(19) United States
(12) Patent Application Publication
(10) Pub. No.: US 2014/0351006 A1
(43) Pub. Date: Nov. 27, 2014

(54) SYSTEM AND METHOD FOR GENERATING AND UTILIZING GLOBAL INFORMATION FROM TRANSACTION RECORDS

(71) Applicant: Cube, Co., Mountain View, CA (US)

(72) Inventors: Joel Christner, Mountain View, CA (US); Charlie Pinto, Mountain View, CA (US)

(21) Appl. No.: 13/907,738

(22) Filed: May 31, 2013

Related U.S. Application Data
(60) Provisional application No. 61/826,402, filed on May 22, 2013.

(51) Int. Cl. G06Q 30/02

(52) U.S. Cl. CPC G06Q 30/0201
USPC 705/7.29

(57) ABSTRACT

A system and method is provided for utilizing global information determined from commercial transactions by first storing data identifying a plurality of store locations of the multi-point merchant. The stored data is associated with an account of the multi-point merchant. A transaction record is received from each of a plurality of devices. Each of the devices is associated with a corresponding store location of the multi-point merchant. The information provided with each transaction record is processed in order to extract information that is non-specific to at least each of a corresponding transaction, a user of the corresponding transaction, and a merchant of the transaction. The processed information is then aggregated based on one or more global criteria so that reports may be generated based on the processed information and the one or more global criteria.

### RELATED APPLICATION

This application claims priority to U.S. Provisional Patent Application No. 61/826,402, filed May 22, 2013 entitled ROLE-BASED TRANSACTION MANAGEMENT SYSTEM FOR MULTI-POINT MERCHANTS; the aforementioned priority application being hereby incorporated by reference in its entirety.

### TECHNICAL FIELD

Examples described herein relate to credit card transactions, and more specifically, to generating and utilizing global information from transaction records.

### BACKGROUND

In recent years, point-of-sale devices and systems have implemented technology that takes advantage of the increasingly functional performance provided by consumer electronic devices such as smart phones and tablets. While in years past, point-of-sale devices were limited to cash registers and credit card terminals (e.g., magnetic readers), present day provides merchants with miniaturized accessory devices that consumer electronic devices (e.g., tablets) that use software applications to process transactions and accept funds.

### BRIEF DESCRIPTION OF THE DRAWINGS

FIG. 1 illustrates an exemplary system for conducting commercial transactions in accordance with present embodiments.

FIG. 2 illustrates an embodiment of a transaction processing system that can be dynamically configured to work with multiple payment processors.

FIG. 3 illustrates a hierarchical tree for storing transaction data in accordance with some embodiments.

FIG. 4 illustrates an exemplary method of conducting a commercial transaction in accordance with present embodiments.

FIG. 5 illustrates an exemplary method of operating a transaction database in accordance with present embodiments.

FIG. 6 illustrates an example merchant interface in which a location-based sales report is displayed for a store manager.

FIG. 7 illustrates an example merchant interface in which a merchant sales report is displayed for an auditor.

FIG. 8 is a block diagram that illustrates a computer system upon which embodiments described herein may be implemented.

### DETAILED DESCRIPTION

Examples described herein provide a system and method for enabling merchants to conduct commercial transactions using merchant-configurable devices and accounts. As used herein, a “merchant” refers to a company or business (e.g., Wal-Mart, Pep Boys, McDonald's, Philz Coffee, etc.) that provides goods and/or services. Furthermore, a particular merchant may be associated with a single outlet (e.g., wherein the merchant is a store owner) or multiple outlets (e.g., wherein the merchant is a franchise). An “operator” herein refers to an actual user (e.g., director, manager, employee, or other type of personnel) that is associated with a particular merchant.

According to some embodiments, a system and method is provided for facilitating and managing credit card transactions. In some examples, a transaction record is received from each of a plurality of payment input (PI) devices. Each PI device is associated with a corresponding store location of a multi-point merchant. In examples described herein, each transaction record is associated with a corresponding store location. An operator of the multi-point merchant is then selectively enabled to access one or more transaction records associated with any of the plurality of store locations based on a pre-determined role of the operator.

Among other benefits, examples described herein recognize that different operators may require access to different types of merchant transaction data, depending on their particular role. For example, an auditor may require access to the merchant's financial data (e.g., for each of the merchant's store locations). However, the details of individual transactions may contain private information, such as customer metadata (e.g., credit card information, cardholder information, etc.) that is not pertinent to the operator's role as an auditor of the merchant. Under conventional implementations, an authorized operator is provided access to all of a merchant's transaction data stored by a typical transaction management system. Accordingly, an auditor, if allowed access to the system, would be able to view more information than he/she should be permitted to.

In contrast, examples described herein recognize that permissions (and/or restrictions) may be selectively placed on the transaction data stored by a transaction management system. These permissions may vary according to predetermined “roles” that the merchant may assign to each operator that is authorized to access transaction data. Therefore, examples herein provide a mechanism for selectively enabling operators to access transaction data based on their respective role assignments.

Examples described herein also recognize that a merchant may not care which acquiring bank and/or payment processor is used to process its transactions. For example, there are many different acquiring banks and payment processors that can process credit card transactions. Each processor may charge a different processing fee and/or provide different services (such as fraud detection). Under conventional implementations, a merchant sets up a merchant account with a particular acquiring bank and is assigned a corresponding merchant identifier (MID) and terminal identifier (TID). Transactions that are identified with a particular MID/TID could only be processed by the acquiring bank/processor that assigned the MID/TID.

In contrast, examples herein recognize that a merchant may wish to pay the lowest processing fees it can, regardless of which acquiring bank or processor is used. It may thus be undesirable to permanently associate a merchant's transactions with a particular MID/TID, since new processors may become available that may offer lower processing fees. Therefore, examples herein provide a mechanism for dynamically altering or configuring the MID/TID information associated with a particular merchant.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

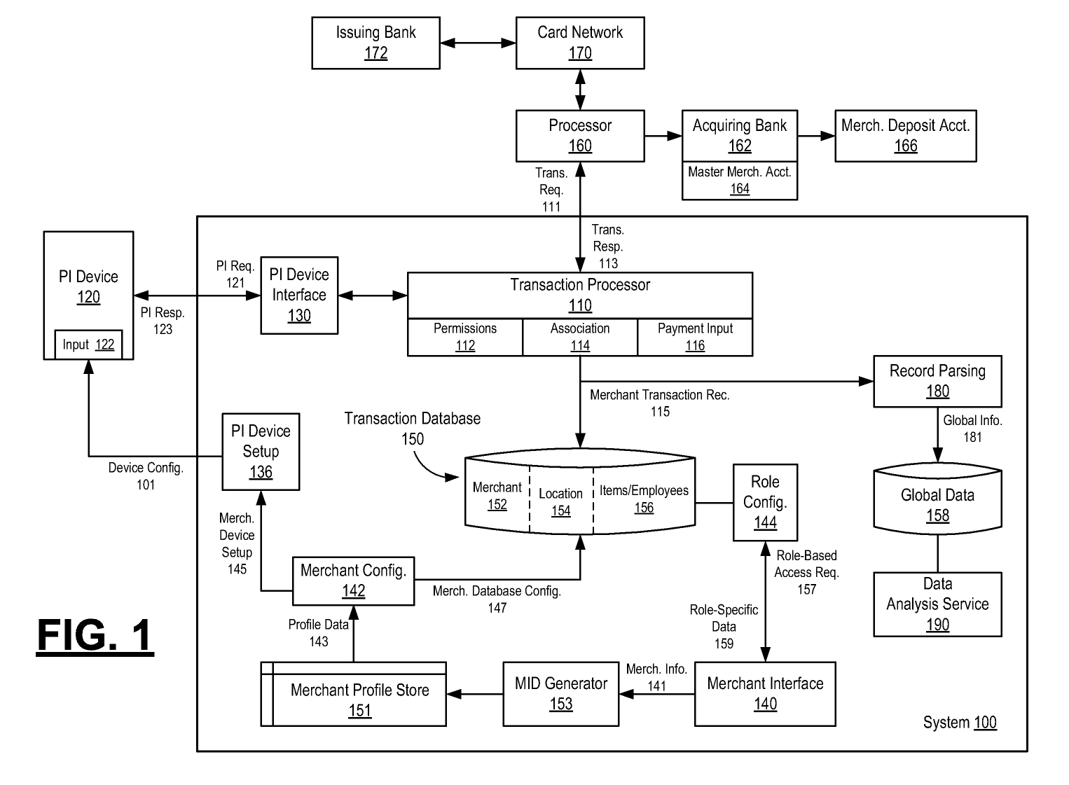

FIG. 1 illustrates an exemplary system for conducting commercial transactions in accordance with present embodiments. With reference to FIG. 1, a payment input (PI) device 120 can be operated by a merchant to access a transaction processing system 100. The PI device 120 may correspond to, for example, a point of sale (POS) device and/or a credit card terminal (CCT). The transaction processing system 100 can be provided as a network service, such as a cloud-based service, or software deployed in the merchant's data center. In one implementation, the transaction processing system 100 is a multi-tenant cloud-based service that hosts merchant transactional activity and services for multiple merchants.

According to some embodiments, the system 100 can include a transaction processing sub-system 110, a transaction database 150, and a merchant interface 140. A given merchant (or operator for the merchant) can access system 100 via merchant interface 140. For example, the merchant may access the system 100 over the Internet, using a web browser, and the interface 140 can be provided as a web page. The merchant can enter information 141 for setting up an account, such as merchant name and locations. Once the account is set up, a programmatic token or identifier may be used to associate the merchant's PI devices with the service 100. Alternatively, the merchant can configure one or more PI devices to specify account information (e.g., login and password) corresponding to the account the merchant established with system 100.

For some embodiments, the information 141 provided by the merchant may identify a bank or financial institution that is designated to receive funds for completed transactions via system 100. As an addition or alternative, the information 141 may include PI device configurations 101, such as specific fields (e.g., inventory items) that are to be included or displayed on the PI device 120 when in use. Still further, the merchant can enter input that designates “roles” for one or more users or operators associated with the merchant profile. By way of example, the merchant may enable one or more operators to view and/or edit the merchant profile information based on their assigned roles. Through the use of roles, a merchant may also limit what information an operator can view (e.g., account information, transaction records, sales reports, customer data, etc.). For some embodiments, roles may also be defined to allow operators to edit transactions.

The merchant information 141 is maintained with a merchant profile store 151. For example, each merchant profile may include a merchant identifier, location identifiers, device identifiers, and/or role designations for the particular merchant. As an addition or alternative, the profile store 151 can also be used to maintain merchant-specified device configurations and information. For some embodiments, the merchant information 141 is provided to a merchant account generator 153 which assigns a merchant identifier (MID) to the merchant. MIDs are typically issued by an acquiring bank to enable the merchant to use the acquiring bank's services in processing credit card transactions. Each MID is further associated with one or more terminal identifiers (TIDs) which are used to link the merchant's payment terminals with the corresponding merchant account.

In some instances, a merchant may have an existing merchant account (e.g., MID) with an acquiring bank. Thus, for some embodiments, the merchant interface 140 may allow the merchant to input its own MID/TID information. If the merchant information 141 includes the merchant's existing MID, the MID generator 153 may simply forward on the existing MID to be stored by the merchant profile store 151. For some embodiments, the MID generator 153 may mark the MID to indicate that it is a merchant-preferred MID. If the merchant does not have an existing MID, or has no preference regarding which acquiring bank and/or processor the system 100 uses to process transactions, the merchant account generator 153 may create a new merchant account with a default (e.g., pre-selected) acquiring bank and processor. Accordingly, the merchant account generator 153 may assign a new MID and one or more TIDs for the merchant.

The merchant may then associate one or more PI devices 120 for use with the system 100. For simplicity, only one PI device 120 is shown in exemplary embodiment of FIG. 1. The PI device 120 may be a software configurable device that can provide POS and/or CCT functionality through, for example, an application or programmatic interface. In such implementations the PI device 120 may correspond to a multi-purpose computing device, including mobile computing devices such as computers, smartphones, and/or tablets. For some embodiments, the PI device 120 may be configured with merchant-specific software configurations to enable various kinds of usages, including franchise-based usage where the merchant is a multi-point merchant. The merchant may associate the PI device 120 with a particular store location and/or one or more employees of that store (e.g., based on the role assignments).

Once a merchant profile has been successfully created, a merchant configurator 142 retrieves profile data 143 stored in the merchant profile store 151 and generates device setup instructions 145 as well as database configuration instructions 147 for the merchant. The device setup instructions 145 may identify all of the PI devices associated with the merchant, and may include configuration instructions for each device. For example, the device setup instructions 145 may include a MID, one or more TIDs, and software and/or hardware configurations for enabling PI devices to create and process transactions through the system 100.

The PI device setup logic 136 receives the device setup instructions 145 from the merchant configurator 142 and generates device configuration instructions 101 for every PI device 120 associated with the merchant. The PI device setup logic 136 may determine, from the device setup instructions 145, how the PI device 120 is to be configured (e.g., which employee(s) may initiate transactions, what inventory items can be sold, what price is to be associated with each item, etc.). The device 120 may then request or retrieve the configuration instructions 101 from the PI device setup logic 136. The device configuration instructions 101 may include the TID assigned to the PI device 120 as well as device-specific software configuration instructions. For example, the device configuration instructions 101 may include a list of items that may be sold through PI device 120 and/or a list of employees that are allowed access (e.g., to log in) to PI device 120.

For some embodiments, each of the merchant's PI devices may retrieve a set of configuration instructions specific to that particular device. For example, each device may be associated with a particular employee and may therefore be configured to be operable only by that employee (e.g., upon receiving the employee's login credentials). For other embodiments, PI devices associated with different store locations may retrieve configuration instructions specific to a particular store. For example, different stores may have different inventory items and/or prices for those items.

The database configuration instructions 147 include parameters (e.g., fields and/or tables) to be created for the merchant in the transaction database 150. For example, the database configuration instructions 147 may identify the merchant, store locations, inventory items, and/or employees associated with the merchant. The transaction database 150 may be partitioned into a merchant table 152, a location table 154, and an items/employees table 156. Accordingly, the database configuration instructions 147 may be used to create: a merchant field, in the merchant table 152, for storing data (e.g., merchant sales reports) pertaining to the merchant as a whole; one or more location fields, in the location table 154, that are linked or associated with the merchant field for storing data (e.g., location-based sales reports) specific to a particular store and/or location; and one or more inventory and employee fields, in the inventory/employee table 156, that are linked or associated with each store location field for storing inventory and employee records (e.g., transaction records) from a particular PI device associated with that store location. It should be noted that the transaction database 150 may store data for multiple merchants, for example, in separate partitions (e.g., by creating separate fields in each of the tables 152, 154, and 156). Further, as described in greater detail below, individual operators may only be allowed selective access to the information stored in the transaction database 150 based on their particular role assignments.

Once the merchant configurator 142 has finished setting up the PI device 120 and transaction database 150, a transaction can be initiated through the given PI device 120. An employee or operator of the PI device 120 may create a transaction for a particular store item on the PI device 120. For example, the employee may specify the item(s) and quantity to be sold via a user interface (UI) provided on the PI device 120. The employee may then input the customer's payment information (e.g., credit card account number, expiration date, cardholder's name, etc.) via an input mechanism 122.

For some embodiments, the input mechanism 122 may be a card reader which receives inputs in the form of a card “swipe.” For example, most credit cards are issued in the form of a magnetic stripe card wherein credit card information (e.g., card or account number, cardholder's name, expiration date, etc.) is stored on a magnetic stripe (“magstripe”) on the reverse side of the card. When the credit card is swiped, the input mechanism 122 may read the credit card information stored on the magstripe and forward this data to the PI device 120 for further processing. For example, the input mechanism 122 may be a peripheral device that is connected or coupled to the PI device 120. Alternatively, the input mechanism 122 may be integrated with the PI device 120.

As an additional or alternative embodiment, the input mechanism 122 may be configured to receive character-based inputs. For example, the input mechanism 122 may include a keyboard or keypad which enables the user to manually “key in” a customer's credit card number and/or other information. As described in greater detail below, for some embodiments, transactions may be processed differently depending on the type of input mechanism used. For example, if the input mechanism 122 is a card reader, a customer must physically produce a credit card to be input (e.g., swiped) into the card reader. Thus, a card swipe input may confirm that the credit card was actually in the customer's possession when the transaction was made, whereas a keyed-in input could not. Card swipe inputs are therefore considered more secure, in general, than keyed-in inputs.

Upon receiving payment information, the PI device 120 signals a PI request 121 to system 100 through a network such as the Internet. The PI request 121 may include the customer's payment information, as well as additional information pertaining to the desired transaction. For example, the PI request 121 may include information identifying the items (including quantity of each item) being purchased, itemized cost of the transaction (including any discounts that may have been applied), the location of the PI device 120, employee metadata (identifying the employee making the sale), and merchant metadata (e.g., MID/TID).

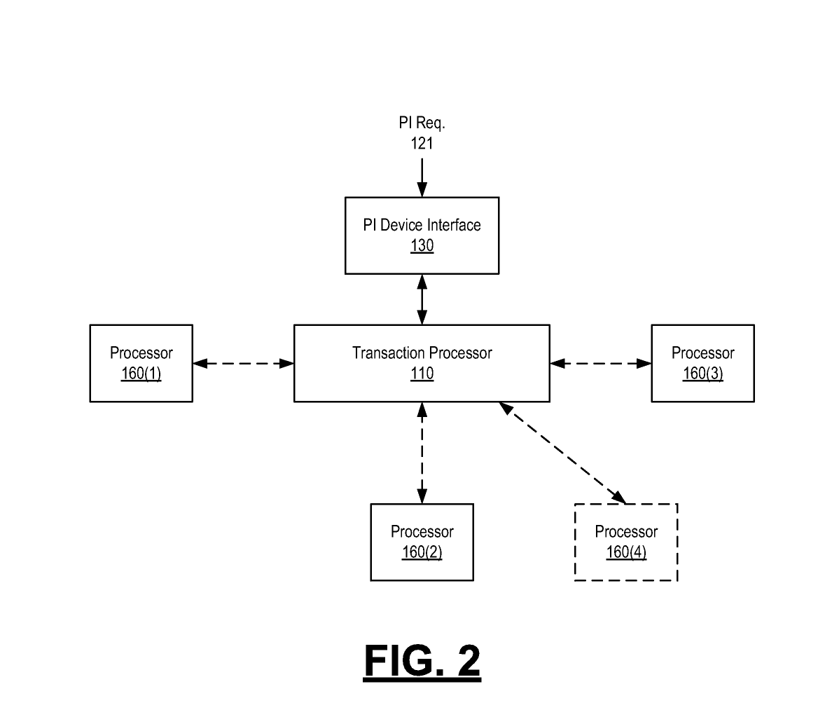

The PI request 121 is sent to a PI device interface 130 which then forwards the request 121 to the transaction processor 110. For some embodiments, the PI device interface 130 may instruct the transaction processor 110 to use a different payment processor than that identified by the MID/TID in the PI request 121 to process payment information included in the PI request 121. For example, as shown in FIG. 2, the transaction processor 110 may be connected to multiple processors 160(1)-160(3), each of which may be associated with a different acquiring bank. Each of the processors may charge different fees and/or provide different services (such as fraud detection) with respect to processing credit card transactions. Accordingly, the PI device interface 130 may dynamically assign a payment processor 160(1)-160(3) to process payment information included in the PI request 121 (e.g., to take advantage of processors offering lower transaction costs and/or better services), regardless of the MID/TID assigned to the PI device 120.

For some embodiments, the PI device interface 130 may dynamically assign a new MID/TID (e.g., by modifying or re-writing the existing MID/TID) for the PI request 121. For other embodiments, the PI device interface 130 may provide routing information to the transaction processor 110 (e.g., without altering the existing MID/TID information of the PI request 121) indicating which payment processor to use. Thus, although the PI device 120 may be pre-associated with a particular payment processor, that association is not permanent. Further, by “virtualizing” the processor assignment (e.g., making the processor assignment transparent to the PI device 120), new processors (e.g., processor 160(4)) may be connected to the system 100 and used by the PI device 120, at any time, without having to reconfigure the PI device 120.

For some embodiments, the PI device interface 130 may selectively assign a payment processor to process payment information from the PI request 121 depending on a merchant preference. For example, as discussed above, the merchant may have a pre-existing MID with a processor that it wishes to use for all credit card transactions. Accordingly, the PI device interface 130 may parse the merchant metadata form the PI request 121 to first determine whether the merchant has selected to use its own existing MID/TID, or whether a new MID/TID was assigned by the MID generator 153. For example, if PI request 121 includes a merchant-preferred MID, the PI device interface 130 may simply forward the request 121 on to the transaction processor 110 without modification. Accordingly, the PI device interface 130 may dynamically associate the PI device 120 with a new payment processor (e.g., by altering the MID/TID information of the PI request 121) only if a new MID/TID was assigned by the MID generator 153 and/or the merchant did not indicate a preference for a particular payment processor.

The transaction processor 110 receives the PI request 121 and transmits a transaction request 111 to a corresponding payment processor 160 based on the MID/TID information included with the PI request 121 and/or routing information provided by the PI device interface 130. For some embodiments, the transaction processor 110 may include a number of sub-modules such as, for example, permissions sub-module 112, association sub-module 114, and payment input sub-module 116. The sub-modules 112, 114, and 116 may be used to perform a number of authentication/verification operations on the received PI request 121 prior to even generating a transaction request 111.

The permissions sub-module 112 verifies whether the merchant operator initiating the transaction is permitted to make such a sale. In general, the permissions sub-module 112 determines whether the operator of the PI device 120 is an employee who is authorized to conduct transactions through that particular PI device 120. For example, a technician may be granted access to the PI device 120 for purposes of debugging issues with the device 120. However, although the technician may have full access to the UI and/or features of the device 120, the permissions sub-module 112 may nonetheless block any actual transactions that are initiated by the technician through the PI device 120.

The association sub-module 114 verifies associations between the item(s) being sold and the merchant that is selling them. For example, the merchant may be a coffee shop or restaurant which only sells beverage and/or food items. Accordingly, the association sub-module 114 may block any transactions where the item for sale is not a food or beverage (such as a computer, television, automobile, etc.). For some embodiments, the association sub-module 114 may use the location information included with the PI request 121 to determine whether a transaction is being conducted at an authorized store location. For example, if the association sub-module 114 detects that the PI device 120 is being used to make a sale outside the vicinity of the particular store location with which the PI device 120 is associated, the association sub-module 114 may block such a transaction.

The payment input sub-module 116 determines whether a credit card was physically used to make the purchase. For example, the payment input sub-module 116 may determine whether payment information (e.g., credit card account number, cardholder's name, etc.) was received via a card swipe input or whether the payment information was manually keyed in by an operator. For some embodiments, the payment input sub-module 116 may limit an amount that may be transacted (e.g., in a day, week, month, and/or year) if the payment information was keyed in manually. The payment input sub-module 116 may thus block any transaction that would exceed the transaction limit associated with the received payment information.

If a transaction is blocked by any of the sub-modules 112, 114, and/or 116, the transaction processor 110 sends a PI response 123 back to the PI device 120 indicating that the sale was denied. For some embodiments, the PI response 123 may also include the particular reason why the sale was denied. However, once a PI a request 121 has been authenticated by each of the sub-modules 112, 114, and 116, the transaction processor 110 stores a record of the transaction (e.g., transaction record 115) in the transaction database 150. Data from the merchant transaction records 115 may be stored in the appropriate fields created for the merchant in each of the merchant table 152, the location table 154, and the items/employees table 156. The transaction processor 110 then transmits a transaction request 111 to the payment processor 160 which includes the customer's payment information (e.g., credit card number, expiration date, cardholder's name, etc.) and other transaction information (e.g., items purchased, price paid, merchant information, etc.). For some embodiments, the transaction processor 110 may send the transaction request 111 to any one of multiple payment processors based on the MID/TID information included with the PI request 121 (e.g., as described above, with respect to FIG. 2).

The payment processor 160 routes the transaction request 111 through the appropriate card network 170 (e.g., Visa, MasterCard, American Express, Discover, etc.) to the issuing bank 172. The issuing bank 172 authenticates the transaction request 111 and responds by either approving or declining the transaction. For example, the issuing bank 172 may verify that the transaction information is valid, the customer has sufficient credit to make the purchase, and the customer's account with the issuing bank 172 is in good standing. This process is known as “authorization.” If the issuing bank 172 approves the transaction, it may place a hold on the funds to be transferred to the acquiring bank. The issuing bank 172 returns a transaction response 113 (e.g., approved/declined), which is routed back through the card network 170 and processor 160, to the transaction processor 110. The transaction processor 110 stores the transaction response 113 with the associated transaction record 115, awaiting settlement. For some embodiments, if the issuing bank 172 declines a transaction, the transaction processor 110 may send a PI response 123 to the PI device 120 indicating that the transaction was declined and delete the transaction record 115 associated therewith.

The transaction processor 110 may initiate a “settlement” process (e.g., which typically occurs at the end of each business day) to capture the held funds, for example, by routing information identifying the approved transactions back to the issuing bank 172, via the processor 160 and the card network 170. The issuing bank 172 then deposits the appropriate funds in a master merchant account 164 of the acquiring bank 162. The master merchant account 164 is the bank account associated with a system operator (i.e., the operator of the transaction processing system 100). Typically the amount deposited in the master merchant account 164 will be equal to the gross receipts (i.e., the amount owed by customers) less interchange/network fees owed to the card network 170 and processing fees owed to the processor 160 (and/or acquiring bank 162). Finally, the acquiring bank 162 deposits the funds acquired by the master merchant account 164 to a particular merchant's deposit account 166. For some embodiments, the transaction processor 110 may control or manage the transfer of funds from the master merchant account 164 to the merchant deposit account 166. For example, the transaction processor 110 may instruct the acquiring bank 162 to deduct the system operator's transaction fees from the amount deposited to the merchant deposit account 166. The system operator's transaction fees may thus be retained in the master merchant account 164.

To access transaction data stored in the transaction database 150, an operator first logs in through the merchant interface 140. The merchant interface 140 determines the operator's role assignment and sends a role-based access request 157 to the role configuration logic 144. In response, the role configuration logic 144 returns role-specific data 159, which includes selected data items from the transaction database 150 that the particular operator is allowed access to, based on the operator's role assignment.

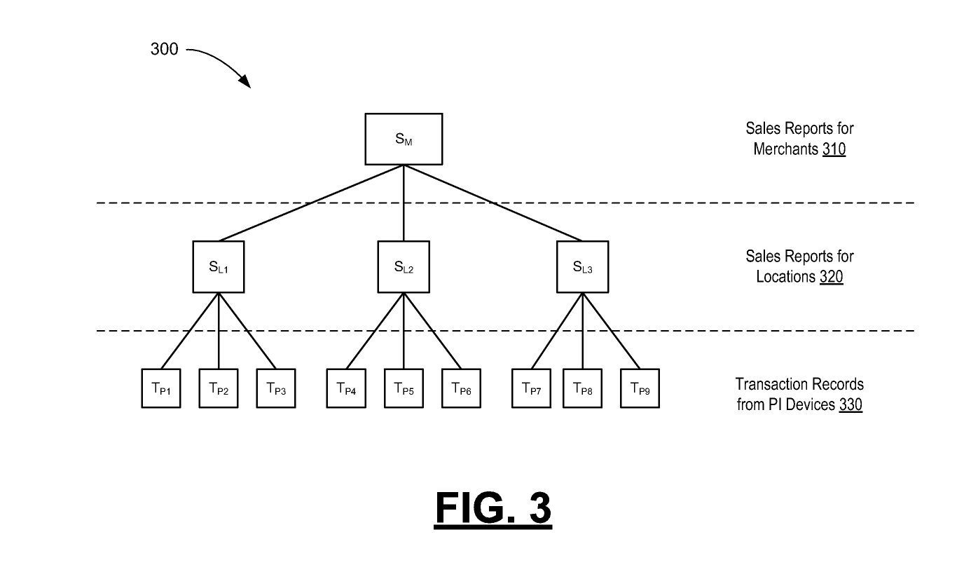

For example, as shown in FIG. 3, the transaction data may be organized in a hierarchical tree 300. At the bottom of the tree 300 are the transaction records 310 from each individual PI device associated with a particular merchant. The next level of the tree 300 includes sales reports 320 for each of the merchant's store locations. The upper-most level of the tree 300 includes sales reports 330 for merchants. The exemplary tree 300 shows transaction data for a single merchant, for simplicity only. It should be noted that the transaction database 150 may be used store similar hierarchical trees for multiple merchants.

A transaction record 310 may include any information collected from a particular transaction (e.g., items purchased, price paid, customer metadata, merchant metadata, etc.). A location-based sales report 320 may track the overall performance (e.g., total amount of sales per day, week, month, year, etc.) of a particular store location. Accordingly, each location based-sales report 320 may include data aggregated from each of the PI devices associated with a particular store location. For example, a first location-based sales report S_{L1} may include sales data from each of the transaction records T_{P1}-T_{P3}; a second location-based sales report S_{L2} may include sales data from transaction records T_{P4}-T_{P6}; and a third location-based sales report S_{L3} may include sales data from transaction records T_{P7}-T_{P9}. A merchant's sales report 330 may track the overall performance of the merchant as a whole (e.g., including all of the merchant's store locations). Accordingly, each merchant sales report 330 may include data aggregated across all of the merchant's PI devices. For example, the merchant sales report S_{M} may include sales data from each of the transaction records T_{P1}-T_{P9}. Alternatively, or in addition, the merchant sales report S_{M} may include data from each of the location-based sales reports S_{L1}-S_{L3}. It should be noted that, for other embodiments, the hierarchical tree 300 may include fewer or more hierarchical levels than those shown in FIG. 3, depending on the desired level of abstraction. For example, sales data may be further aggregated based on sales “regions,” wherein each sales region includes a number of store locations.

Role-based access allows an operator to view selected transaction records 310 and/or sales reports 320-330 based on the role assigned to that operator. For example, a store manager of location L1 may be allowed to access the sales reports 320 for that particular location (i.e., S_{L1}) and individual transaction records 310 originating from that store (i.e., T_{P1}-T_{P3}). However, the store manager of location L1 may be prohibited from accessing sales reports 320 for any of the other store locations (e.g., S_{L2} or S_{L3}) or any of the transaction records 310 associated therewith (e.g., T_{P4}-T_{P9}). Accordingly, the store manager may also be prohibited from accessing the merchant's sales report 330 (i.e., S_{M}). In another example, an auditor may be allowed access only to the merchant's sales report 330 (and possibly the location-based sales reports 320), while being prohibited from accessing the individual transaction records 330 which may contain private information (e.g., customer metadata) that is not pertinent to the operator's role as an auditor.

For some embodiments, the merchant transaction records 115 are additionally provided to a record processing/parsing logic 180. The record processing/parsing logic 180 may be configured to parse the merchant transaction records 115 for a variety of global information 181, which is subsequently sent to the global data store 158 for storage. The global information 181 may identify who (customer) purchased what (items and quantity) from whom (merchant), at which location (store), in what amount (price), using what payment (credit card), and when (date of transaction). The data analysis service 190 may access the information stored in the global data store 158 for purposes of generating targeted analytics. For example, the data analysis service 190 may use the information stored in the global database 158 to track a particular customer's purchases across multiple merchants (e.g., to identify the customer's interests and/or purchasing patterns). As another example, the data analysis service 190 may look for similar purchases by multiple customers from multiple merchants (e.g., to determine associations between items sold by different merchants).

Methodology

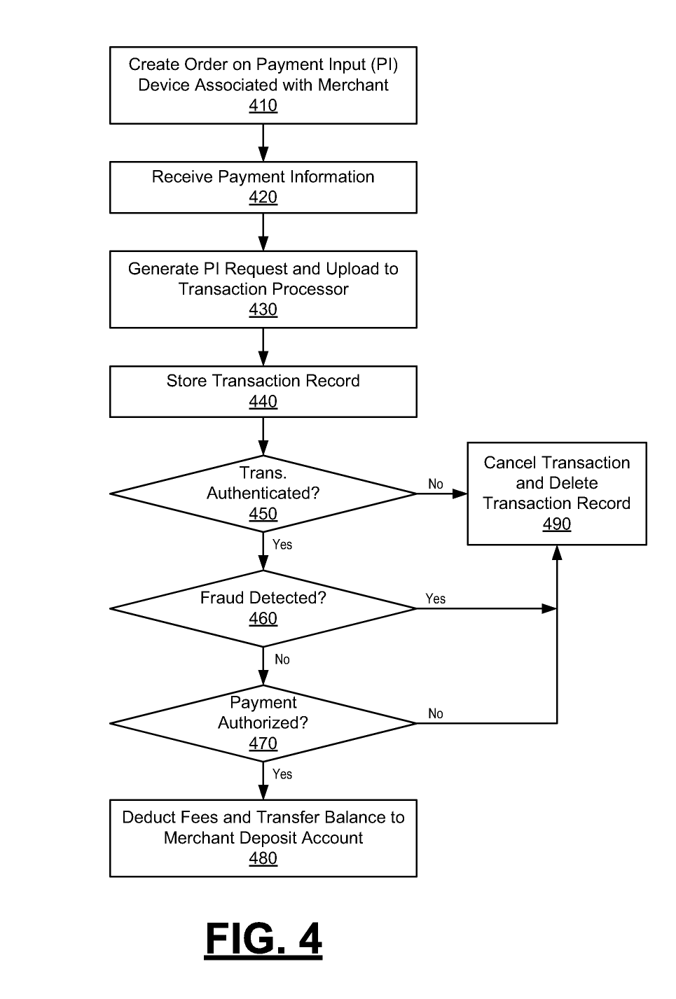

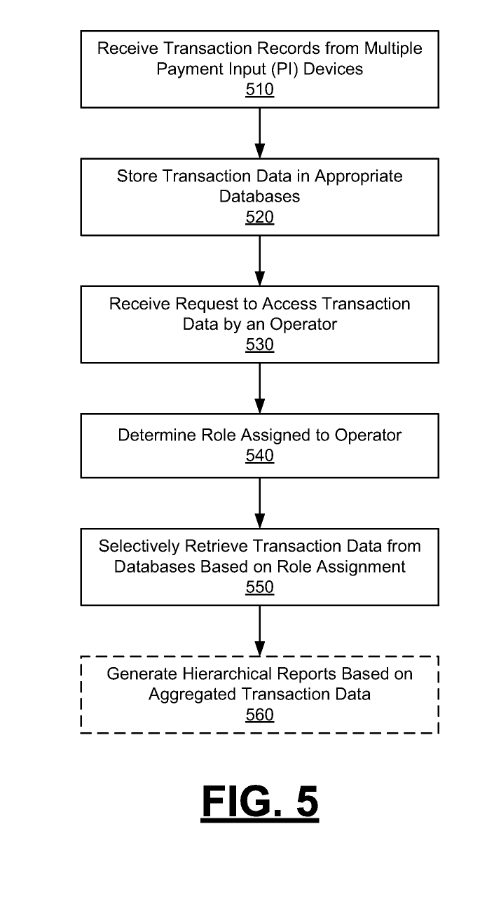

FIG. 4 illustrates an exemplary method of conducting a commercial transaction in accordance with present embodiments. FIG. 5 illustrates an exemplary method of operating a transaction database in accordance with present embodiments. Methods such as described by examples of FIGS. 4 and 5 may be implemented using, for example, a system such as described with respect to FIG. 1. Accordingly, reference may be made to elements of FIG. 1 for purpose of illustrating suitable components for performing a step or sub-step being described.

With respect to FIG. 4, an order is created on a PI device associated with a particular merchant (410). For example, an employee or operator of the PI device 120 may create the transaction by inputting the item(s) and quantities of each item to be sold via a UI provided on the PI device 120. For some embodiments, the operator may select the item(s) from an inventory list provided on the PI device 120. The inventory list and/or UI may be managed and updated remotely by the merchant (e.g., through the merchant interface 140).

A customer's payment information is then received via the PI device (420). As described above, the PI device 120 is coupled to (or includes) input mechanism 122, which may include a card reader and/or a manual character input device. Thus, for some embodiments, the payment information may be input by swiping a customer's credit card through a card reader. Alternatively, the payment information may be manually keyed in via the character input device. The payment information may include, for example, the credit card account number, the credit card expiration date, and the cardholder's name.

The PI device generates a PI request which is then uploaded to a transaction processor (430). For example, the PI device 120 may transmit PI request 121 to transaction processor 110 via a network such as the Internet. The PI request 121 may include information identifying the items being purchased, itemized cost of the transaction, location of the PI device, employee metadata, and/or merchant metadata. For some embodiments, the PI request 121 may first be received by a PI device interface 130 which may dynamically alter the MID/TID of the PI request 121 (e.g., if the merchant does not have an existing merchant account or preference for a particular acquiring bank/processor) before forwarding on the request 121 to the transaction processor 110.

The transaction processor subsequently stores a record of the corresponding transaction (440). For example the transaction processor 110 may store a transaction record 115, which includes data from the PI request 121, in the transaction database 150. Specifically, transaction data may be stored in the appropriate fields created for the merchant in each of the merchant table 152, the location table 154, and the items/employees table 156.

Data from the PI request is then analyzed to determine whether the transaction is authenticated (450). For example, the transaction processor 110 may process the PI request through a number of sub-modules 112, 114, 116, and 118. Specifically, the sanitization sub-module 112 verifies whether the customer is allowed access to the particular merchant, location, and/or items involved in the transaction. The permissions sub-module 114 verifies whether the merchant operator initiating the transaction is permitted to make such a sale. The association sub-module 116 verifies associations between the item(s) being sold, the location of the sale, and/or the merchant that is initiating the sale. Lastly, the payment input sub-module 118 determines whether a credit card was physically used to make the purchase and, if not, whether the transaction would exceed a transaction limit associated with the received payment information. The authentication process may fail if at least one of the sub-modules 112, 114, 116, or 118 blocks the transaction.

If the transaction is authenticated (450), data from the PI request is further analyzed for purposes of fraud detection (460). For example, the transaction processor 110 may send the customer's payment information (e.g., credit card number, expiration date, cardholder's name, etc.) and other transaction information (e.g., items purchased, price paid, merchant information, etc.), as a transaction request 111, to payment processor 160. The payment processor 160 may then run various fraud detection analyses on the received transaction request 111. Such fraud detection measures may be well known in the art. For example, the processor 160 may detect a fraudulent transaction if the customer's credit card was used to make a large purchase right after a series of small purchases.

If no fraud is detected (460), the payment information is then forwarded to an issuing bank for authorization (470). For example, if the payment processor 160 does not detect a fraudulent transaction, it may forward the transaction request 111 to the card network 170, which then routes the request 11 to the appropriate issuing bank 172. The issuing bank 172 either approves (i.e., authorizes) or declines the transaction after verifying that the transaction information is valid, the customer has sufficient credit to make the purchase, and/or the customer's account is in good standing.

If the payment is authorized (470), the transaction processor may facilitate the transfer of funds from the issuing bank to a merchant deposit account by deducting transaction fees from the amount deposited in the merchant deposit account (480). For example, during a settlement process, the issuing bank 172 deposits funds associated with the transaction (minus interchange and processing fees) to the master merchant account 164 of the acquiring bank 162. The transaction processor 110 may then instruct the acquiring bank 162 to deduct the system operator's transaction fees and transfer the remaining funds received from the issuing bank 172 to the merchant deposit account 166. The system operator's transaction fees may be retained in the master merchant account 164.

If, at any time, the transaction fails authentication (450), a fraudulent transaction is detected (460), and/or payment is declined by the issuing bank (470), the transaction processor may terminate the transaction and delete the corresponding transaction record (490). For some embodiments, a fraudulent transaction may be detected after funds have already been transferred from the acquiring bank to the issuing bank. In such cases, the transaction processor 110 may receive a refund request (e.g., from the PI device 120 which initiated the original transaction). In response to the refund request, the transaction processor 110 may retrieve the transaction record associated with the fraudulent transaction from the transaction database 150. The transaction processor 110 may then withdraw the payment amount from the merchant deposit account 166 and return the funds to the issuing bank 172 (e.g., to be credited to the customer's account).

FIG. 5 illustrates an exemplary method of operating a transaction database, which is herein described with reference to the system 100 of FIG. 1. The system 100 first receives transaction records from multiple PI devices (510). For example, each PI device may be associated with a particular store location. For some embodiments, a merchant may have multiple store locations, with each location having one or more PI devices associated therewith. The transaction records may be sent with PI requests 121 and may thus include information identifying the items being purchased, cost of the transaction, location of the PI device, employee metadata, and/or merchant metadata.

The system 100 parses transaction data from the transaction records and stores the transaction data in the appropriate fields of the transaction database 150 (520). For example, data pertaining to a merchant as a whole (e.g., for generating merchant sales reports) may be stored in a field allocated for that particular merchant in the merchant table 152. Data pertaining to a particular store location (e.g., for generating location-based sales reports) may be stored in a field allocated for that location in the location table 154. Data pertaining to item inventory and/or the employees at a particular location (e.g., transaction records) may be stored in one or more fields allocated for that location in the items/employees table 156. For some embodiments, the transaction data may be stored in the form of a hierarchical tree (e.g., as described above with respect to FIG. 3)

The system 100 then receives a request by an operator to access the transaction data stored in the transaction database 150 (530). For example, the operator may access the system 100, via the merchant interface 140, from a remote computer or terminal. For some embodiments, the operator may log in to the system 100 by providing his/her login credentials to the merchant interface 140. The merchant interface 140 may then authenticate the operator by verifying his/her login credentials.

The system 100 may then determine a role assigned to the operator based on his/her login credentials (540). For example, each operator may have a particular user account associated with the system 100 which uniquely identifies the operator's role assignment. The role of each operator may be assigned by the merchant. For some embodiments, roles may be assigned and reassigned to different operators. For example, if a store manager for a particular store location is fired or resigns, the role of store manager for that location may be reassigned to a different operator. Furthermore, the same role may be assigned to multiple operators. For example, the merchant may be governed by multiple directors, each of whom may require unrestricted access to all of the merchant's transaction data.

Finally, the system 100 selectively retrieves transaction data from the transaction database 150 based on the role of the operator (550). For example, a store manager of a particular store location may be permitted to access any transaction data originating from that particular location (e.g., data stored in the corresponding fields of the location table 154 and the items/employees table 156 allocated for that location) while being prohibited from viewing or accessing transaction data pertaining to any other location (or the merchant as a whole). In another example, an auditor may be permitted to access only the merchant's financial data (e.g., data stored in the merchant table 152 and the location table 154) while being prohibited from viewing or accessing transaction data pertaining to item inventory or employee performance (e.g., data stored in the items/employees table 156).

For some embodiments, the system 100 may additionally generate hierarchical sales reports based on aggregated transaction data (560). As described above, with respect to FIG. 3, the system 100 may generate merchant and location-based sales reports 330 and 320, respectively, for different levels of the hierarchical tree 300. For example, the transaction data stored in the merchant table 152 may include financial data aggregated from PI devices at each of the merchant's store locations. However, a director may wish to track the overall performance of the merchant across all of its store locations over one or more periods (e.g., daily, weekly, monthly, yearly, etc.). Accordingly, the system 100 may apply one or more performance metrics to the data retrieved from the merchant table 152, for example, to generate the merchant sales report 330. The system 100 may also apply similar performance metrics to data retrieved from the location table 154 to generate the location-based sales reports 320.

### EXAMPLES

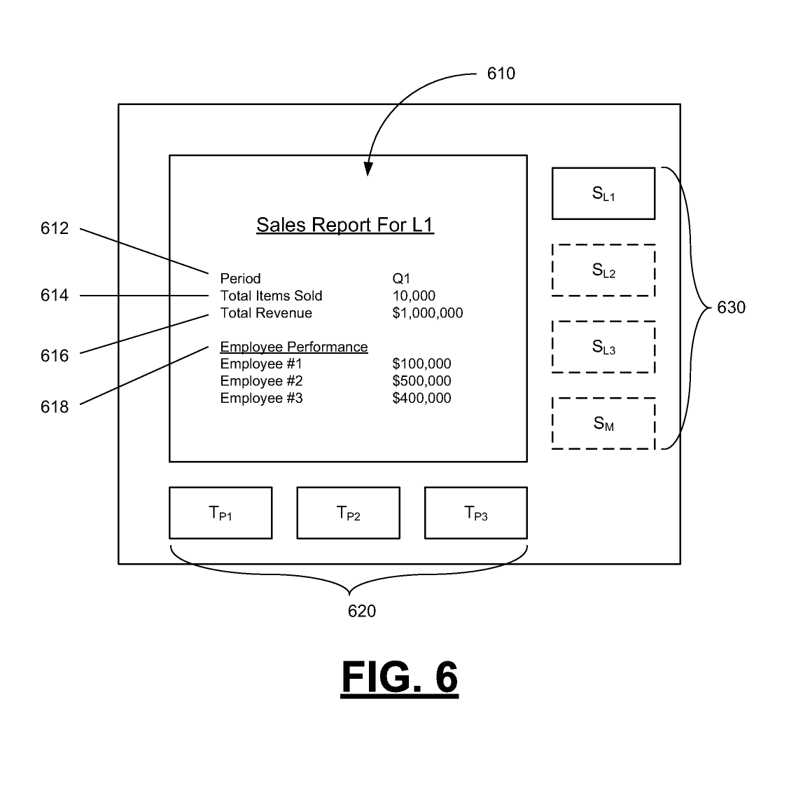

FIG. 6 illustrates an example merchant interface in which a location-based sales report 610 is displayed for a store manager. In the example provided, the merchant interface can provide a web page, or set of web pages, where transaction data can be viewed. Detailed information may accompany the location-based sales report 610. For example, the detailed information may include a set of performance parameters 612-616 for the location L1. The performance parameters include the period 612 over which the transaction data is aggregated (e.g., “Q1”), the total number of items sold 614 at the store location L1 (e.g., “10,000”), and the total revenue 616 generated by the store location L1 (e.g., “$1,000,000”). The location-based sales report 610 may also include employee performance data 618 which allows the store manager to track the performance of each of the employees at the store location L1 (e.g., employee #'s 1-3).

The merchant interface further displays links to the actual transaction records 620 received from each of the PI devices associated with the store location L1 (e.g., T_{P1}, T_{P2}, and T_{P3}). However, links to the other sales reports 730 (e.g., S_{L2}, S_{L3}, and S_{M}) are disabled. For example, because the merchant interface is provided based on an operator's particular role assignment, the current operator's role as the store manager at location L1 may not allow him/her access to the sales reports for other stores locations (and/or the merchant as a whole) which may contain location-specific information (e.g., total sales by the locations L2 and L3) that is not pertinent to the operator's role as a store manager at location L1.

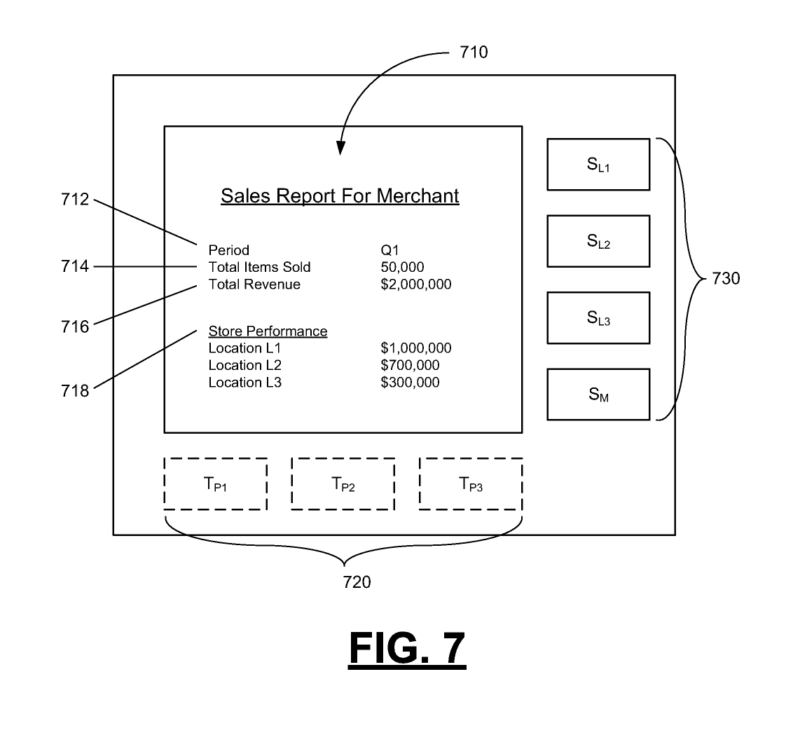

FIG. 7 illustrates an example merchant interface in which a merchant sales report 710 is displayed for an auditor. As described above, the merchant interface can provide a web page, or set of web pages, where transaction data can be viewed. The merchant sales report 720 may include detailed information pertaining to a set of performance parameters 712-716 for the merchant as a whole. The performance parameters include the period 712 over which the transaction data is aggregated (e.g., “Q1”), the total number of items sold 714 across all of the merchant's store locations (e.g., “50,000”), and the total revenue 716 generated by the merchant as a whole (e.g., “$2,000,000”). The merchant sales report 710 may also include store performance data 718 which allows the auditor to track the sales of each of the merchant's store locations (e.g., locations L1-L3).

The merchant interface further displays links to location-based sales reports 730 for each of the merchant's store locations (e.g., S_{L1}, S_{L2}, and S_{L3}). However, links to the actual transaction records 720 received from the merchant's PI devices (e.g., T_{P1}, T_{P2}, and T_{P3}) are disabled. For example, because the merchant interface is provided based on an operator's particular role assignment, the current operator's role as an auditor may not allow him/her access to the detailed transaction records which may contain private information (e.g., customer metadata) that is not pertinent to the operator's role as an auditor. For some embodiments, the links to the transaction records 720 may be hidden from view.

Computer System

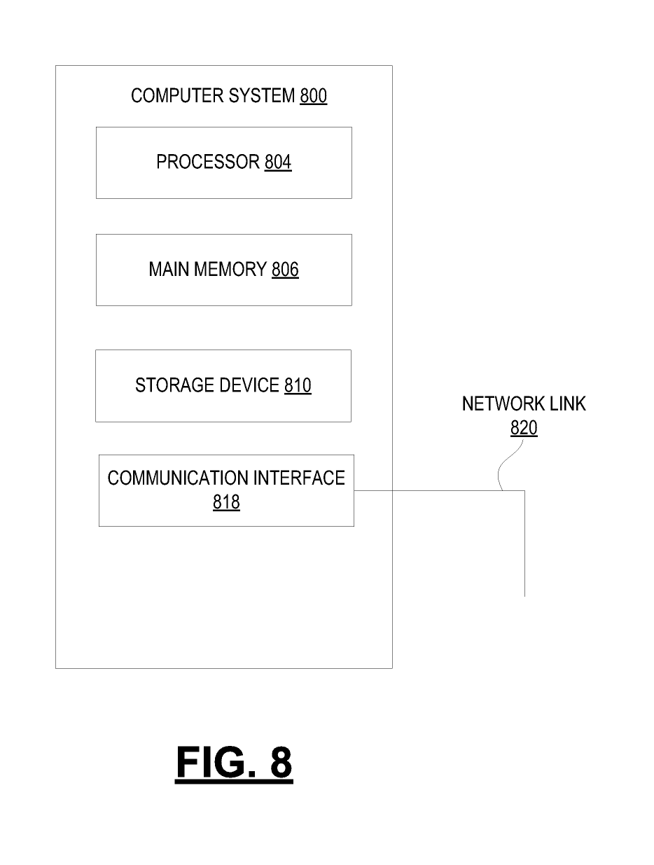

FIG. 8 is a block diagram that illustrates a computer system upon which embodiments described herein may be implemented. For example, in the context of FIG. 1, system 100 may be implemented using one or more servers such as described by FIG. 8.

In an embodiment, computer system 800 includes processor 804, memory 806 (including non-transitory memory), storage device 810, and communication interface 818. Computer system 800 includes at least one processor 804 for processing information. Computer system 800 also includes the main memory 806, such as a random access memory (RAM) or other dynamic storage device, for storing information and instructions to be executed by processor 804. Main memory 806 also may be used for storing temporary variables or other intermediate information during execution of instructions to be executed by processor 804. Computer system 800 may also include a read only memory (ROM) or other static storage device for storing static information and instructions for processor 804. The storage device 810, such as a magnetic disk or optical disk, is provided for storing information and instructions. The communication interface 818 may enable the computer system 800 to communicate with one or more networks through use of the network link 820 (wireless or wired line). The communication interface 818 may communicate with bidders and auction participants using, for example, the Internet.

Embodiments described herein are related to the use of computer system 800 for implementing the techniques described herein. According to one embodiment, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for utilizing information determined from commercial transactions, the method being implemented by one or more processors and comprising:
storing data associated with an account of the multi-point merchant, the data identifying a plurality of store locations of the multi-point merchant;
receiving a transaction record from each of a plurality of devices, each device being associated with a corresponding store location from the plurality of store locations of the multi-point merchant;
storing each transaction record with the corresponding store location of the account using the stored data that identifies the plurality of store locations of the multi-point merchant;
processing information provided with each transaction record in order to extract detailed information that is specific to a corresponding transaction;
aggregating the processed information based on one or more global criteria; and
generating one or more reports based on the processed information and the one or more global criteria.

2. The method of claim 1, wherein the detailed information for each transaction record includes information identifying: (i) a customer involved in the transaction, (ii) one or more items purchased by the customer, (iii) a price associated with each of the one or more items, (iv) a merchant involved in the transaction, (v) the corresponding store location, (vi) payment information associated with the customer, and (vii) a date and/or time of the transaction.

3. The method of claim 1, wherein the one or more global criteria is based on a merchant class criterion, and wherein the processed information is aggregated across multiple merchants.

4. The method of claim 1, wherein the one or more global criteria is based on a customer class criterion, and wherein the processed information is aggregated across multiple customers.

5. The method of claim 1, further comprising detecting a trend based on the processed information and the one or more global criteria.

6. The method of claim 4, wherein detecting a trend includes analyzing a customer's purchasing patterns across multiple merchants.

7. The method of claim 5, further comprising determining one or more interests for that customer based on the purchasing patterns.

8. The method of claim 4, wherein detecting a trend includes determining an association between items sold by different merchants.

9. The method of claim 1, wherein the one or more global criteria includes geolocation data, and wherein generating the one or more reports includes generating a report that is specific to the geolocation data.

10. The method of claim 1, wherein receiving the transaction record includes receiving non-transaction information from each of the plurality of devices at the time of each transaction, and wherein generating one or more reports is based on the non-transaction information.

11. A computer system comprising:
a memory that stores instructions;
one or more processors, which access instructions from the memory to perform operations including:
store data associated with an account of the multi-point merchant, the data identifying a plurality of store locations of the multi-point merchant;
receive a transaction record from each of a plurality of devices, each device being associated with a corresponding store location from the plurality of store locations of the multi-point merchant;
store each transaction record with the corresponding store location of the account using the stored data that identifies the plurality of store locations of the multi-point merchant;
process information provided with each transaction record in order to extract detailed information that is specific to a corresponding transaction;
aggregate the processed information based on one or more global criteria; and
generate one or more reports based on the processed information and the one or more global criteria.

12. A computer-readable medium that stores instructions that, when executed by one or more processors, cause the one or more processors to perform operations comprising:
storing data associated with an account of the multi-point merchant, the data identifying a plurality of store locations of the multi-point merchant;
receiving a transaction record from each of a plurality of devices, each device being associated with a corresponding store location from the plurality of store locations of the multi-point merchant;
storing each transaction record with the corresponding store location of the account using the stored data that identifies the plurality of store locations of the multi-point merchant;
processing information provided with each transaction record in order to extract detailed information that is specific to a corresponding transaction;
aggregating the processed information based on one or more global criteria; and
generating one or more reports based on the processed information and the one or more global criteria.
